(19) United States
(12) Patent Application Publication
(10) Pub. No.: US 2004/0058602 A1
(43) Pub. Date: Mar. 25, 2004

(54) Composite poly insulation facing material

(76) Inventor: Wallace J. Maynard, Wrightstown, WI (US)

Correspondence Address: Philip M. Weiss, Weiss & Weiss, 310 Old Country Road, Garden City, NY, 11530, US

(21) Appl. No.: 10/654,211

(22) Filed: Sep. 2, 2003

Related U.S. Application Data
(63) Continuation-in-part of application No. 10/021,184, filed on Oct. 30, 2001.

(51) Int. Cl. B32B 5/22; B32B 5/18; B32B 9/00; B32B 5/02; B32B 3/00

(52) U.S. Cl. 442/76; 442/59

(57) ABSTRACT

The present invention relates to insulation facing materials for use as a protective moisture barrier facing sheet (vapor retarding facing) for fiberglass and other home and commercial insulation batting used in wall and ceiling applications, and methods of making the barrier facing sheet. More particularly, the invention relates to composite coextrusion facing materials used for fiberglass and other possible types of insulation.

### RELATED APPLICATIONS

The following application is a continuation in part of U.S. patent application Ser. No. 10/021,184 filed Oct. 30, 2001.

### FIELD OF THE INVENTION

The present invention relates to insulation facing materials for use as a protective moisture barrier facing sheet (vapor retarding facing) for fiberglass and other home and commercial insulation batting used in wall and ceiling applications, and methods of making the barrier facing sheet. More particularly, the invention relates to composite coextrusion facing materials used for fiberglass and other possible types of insulation.

### BACKGROUND OF THE INVENTION

Rolls and batts of composite facing are used by most fiberglass and other insulation manufacturers to provide a moisture barrier facing and carrier sheet for adhering the insulation to ceilings and walls of commercial and residential buildings. These batts and rolls can be found in retail stores packaged in various widths and lengths for consumer purchase. The majority of this material, however, is sold through distributors directly to installers and builders. In addition to supporting fiberglass and other insulation materials for installations, the facing provides a moisture barrier and is printed with the R (Heat Resistance) factor and other information. The physical strength of the facing also is important in order to support the weight of the insulation during the installation process, whereby insulation is normally stapled inside wall or ceiling cavities. The facing material further must be strong enough to prevent tearing and jeopardizing the integrity of the moisture barrier. The facing provides a barrier that prevents moisture from the warmer building from condensing into the insulation and rendering it less effective.

Conventional home and commercial insulation facings include paper/polyethylene or paper/asphalt and foil combinations that are usually printed and flanged in rolls or folded batts. A drawback of polyethylene coated facing paper can be the low burst/tear strength. This occurs when the product is manufactured at the minimum polyethylene coating weights to meet moisture barrier requirements. Often installers complain about the product ripping or tearing during installation. It is not cost-effective to apply heavy coats of polyethylene coatings; higher polyethylene weights also create a thicker product thereby reducing the amount of material that can be put on a roll and causing additional rolls, changes during manufacturing and freight cost inefficiencies.

U.S. Pat. No. 6,191,057 relates to a facing system for insulation product wherein the facing material is a coextruded polymer film of barrier and bonding layers, with the bonding layer having a softening point lower than the softening point of the barrier layer. The facing is adhered to the batt of insulation by the attachment of the bonding layer to the fibers in the batt due to the softening of the bonding layer. The facing also includes a carrier layer of high or low density polyethylene film, as opposed to asphalt/kraft paper facing or other cellulosic materials used in conventional facing systems. The film carrier layer enhances the adaptabiliy and sealing of the insulation product for hard-to-install areas by making cutting of the insulation facing material easier; whereas the conventional asphalt/kraft paper facing systems tend to be brittle and difficult to seal in unique installations, such as when installing around electrical outlet boxes.

U.S. Pat. No. 5,922,626 relates to a self-adhering tape-like or fibrous reinforcing material which consists of laminates of at least two or more coextruded layers of at least one high-temperature stable plastic material (A) and at least one low-melting plastic material (B). The low-melting plastic material (B) has self-adhering binder properties whereas the high-temperature stable plastic material (A) is suitable for conferring strength properties to nonwoven textile fabrics, in particular in the automobile area.

U.S. Pat. No. 5,746,854 relates to a method of manufacturing/making mineral fiber (e.g., fiberglass) thermal insulation batt wherein a base mineral fiber layer is impregnated with a two-layer layering system so as to produce a batt which is substantially vapor impermeable with a perm vapor rating less than about one. The first layer of the layering system is a low melt material, while the second layer is a high melt material, the first layer being sandwiched between the base insulating layer and functioning to bond the layering system to the base.

U.S. Pat. No. 5,733,624 relates to a mineral fiber (e.g., fiberglass) thermal insulation batt wherein a base mineral fiber layer is impregnated with a two-layer system so as to produce a batt which is substantially vapor impermeable with a perm vapor rating less than about one. The first layer of the layering system is a low melt material, while the second layer is a high melt material, the first layer being sandwiched between the base insulating layer and the second layer and functioning to bond the layering system to the base. This patent relates to a coex film of low density resin with EVA and high density. This product is co-extruded right onto the fiberglass batt in-line. It is referred to as impregnated right into the fiberglass.

U.S. Pat. No. 6,191,057 relates to a facing system for an insulation product. An insulation product includes an elongated batt of fibrous insulation material and a facing adhered to a major surface of the batt, wherein the facing is a co-extruded polymer film of barrier and bonding layers. The bonding layer has a softening point lower than the softening point of the barrier layer being one or more materials of the group consisting of ethylene N-butyl acrylate, ethylene methyl acrylate and ethylene ethyl acrylate, and wherein the facing has been heated to a temperature above the softening point of the bonding layer but below the softening point of the barrier layer. The facing is adhered to the batt by the attachment of the bonding layer to the fibers in the batt due to the softening of the bonding layer.

### SUMMARY OF THE INVENTION

The present invention relates to a coextruded coated paper material comprising: a first layer comprising paper; a second layer comprising a clear polymer resin material; and a third outside sealant layer comprising a black low melt polymer resin; wherein all three layers are integrally bonded together. It is an object of the present invention for the polymer resin layers to provide a moisture vapor barrier and improved strength to the coextruded material. It is an object of the third outside layer to provide an adhesion or bond to the insulation. It is an object of the second layer to prevent bleed-through of the black resin material, which results in poor appearance and jeopardizes the integrity of the moisture/vapor barrier. It is further an object of the present invention for the first, second, and third layers to be continuously bonded together such that there are substantially no air pockets in between. Substantially no air pockets is defined as less than about three air pockets in approximately ten square feet of the coextruded material.

It is an object of the present invention for the coextruded material to comprise a first layer of cellulosic material having fold retention and a basis weight of about 30 to 55 lbs./3,000 sq. ft. Fold retention is defined as the ability to maintain a crease. It is a further object of the present invention that the cellulosic layer comprises a primed or unprimed cellulosic material such as machine finished paper, machine glazed paper, extensible paper or Kraft paper.

It is an object of the present invention for the second layer to comprise a clear polymer resin selected from the group consisting of low density polyethylene, polypropylene or high density polyethylene.

It is an object of the present invention for the third layer to comprise a black polymer resin of low density, high melt index polyethylene that can be flame or corona (electrically) treated to enhance adhesion or bonding to fiberglass or other insulation. It is an object of the present invention for the third layer to be pigmented with a black pigment.

It is an object of the present invention for the coextruded material to be faced with a roll or batt of insulation. It is also an object of the present invention for the coextruded material to provide a barrier to effectively prevent moisture absorption into the insulation. It is an object of the present invention for the second clear polymer resin layer to prevent bleed-through of the black pigmented resin layer when the black sealant layer is heated. With current insulation facing materials on the market, overheating of the black sealant layer results in development of pinholes through which the black resin material can bleed to the paper layer. Without the second clear polymer layer, the black polymer resin sometimes bleeds through to the paper layer causing a disruption of the moisture/vapor barrier and unsightly appearance. An object of the present invention is to prevent the bleed-through of the black pigmented layer to the paper layer.

It is also an object of the present invention for the coextruded material to have a burst strength value of approximately 60 or greater. It is an object of the present invention for the coextruded material to have a WVTR (water vapor transmission rate) of approximately 0.50 or less.

The present invention also relates to a process for making a composite material comprising: a first sheet of cellulosic material and a second coextruded layer comprising two layers of polymer resin materials, a clear polymer resin material and a black low melt polymer resin. The coextrusion layers are applied to the surface of the first layer. The first layer and the two coextruded layers are conveyed into a laminating apparatus wherein the layers are integrally bonded to form an integral composite material.

The present invention relates to a co-extrusion of polymer resin materials to be part of a paper substrate structure used for insulation facing. Fiberglass and other insulating type materials are incorporated with the coextruded substrate, laminated to the polymer resin surface to form a composite product used in the building industry. The paper substrate has a release characteristic which, during the process of creating the coextruded material, does not stick to the drum like film. The paper substrate provides strength and rigidity to the product and does not melt.

It is an object of the present invention to provide a thin, high strength, moisture barrier coating that addresses the installers' concerns for tear strength, and allows maximum footage at normal roll diameters and meets or exceeds the moisture barrier specifications. These results can be measured by burst testing, MVTR (moisture vapor transmission rates), and actual roll diameters versus footage on the roll.

The coextrusion process of the present invention comprises applying two different resins, simultaneously, to one side of a paper substrate. The first clear resin layer provides high burst strength (bursts at approximately 60 or greater) and low moisture transmission rates (WVTR test values of 0.50 or less) and prevents the bleed-through of the black pigmented resin material to the paper substrate. The second resin layer provides the low temperature sealant strength (100 degrees Celsius or less) required for good adherence to fiberglass or other insulation product. This composite coextruded product provides the desired improvements at the same or lower cost to the fiberglass or other insulation producers.

The coextrusion layers of the invention can comprise either a layer of linear low density or high density polyethylene, or polypropylene homopolymer or copolymer, all of which provide higher strength (burst values at 60 or greater versus 30 with a single layer of low density polyethylene of comparable thickness), and lower moisture vapor transmission rates (WVTR test values of 0.50 or less versus 1.00 with a single layer of LDPE). The outer coextruded layer is a high melt index (approximately 10.0 melt index or higher) low density polyethylene providing improved bonding (visual pulling away of fiberglass strands when separated) or adhesion to the fiberglass or other insulation product.

### BRIEF DESCRIPTION OF THE DRAWINGS

FIG. 1 is a cross-sectional view of the coextrusion layer as applied to paper.

FIG. 2 is a schematic view of an apparatus used to produce the coextrusion material of FIG. 1.

### DETAILED DESCRIPTION OF THE INVENTION

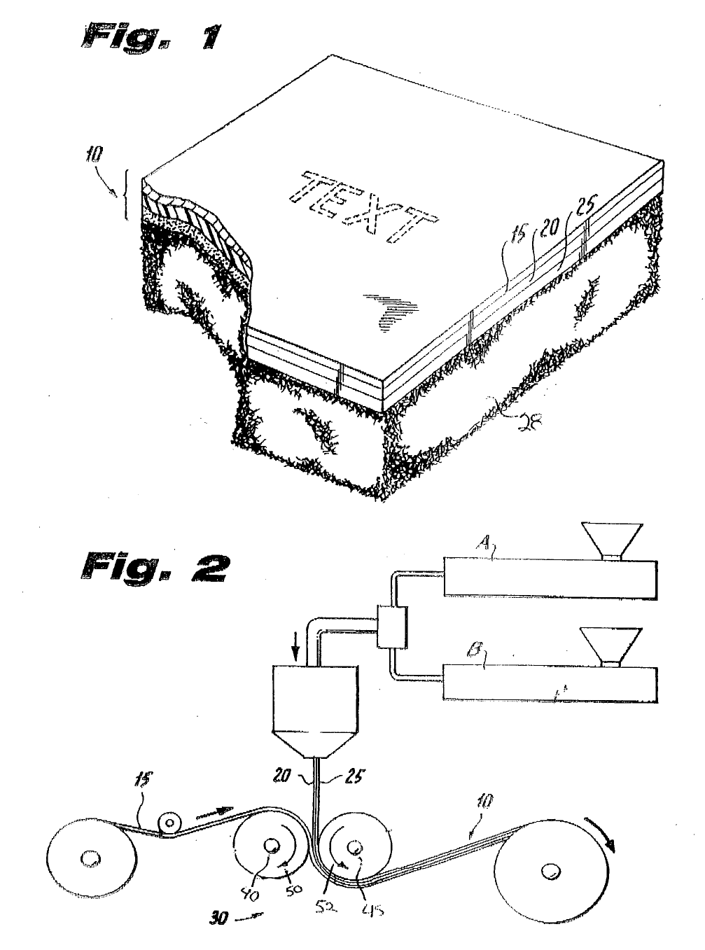

FIG. 1 shows an embodiment of the coextrusion material of the present invention. The composite material 10 is made of a first layer 15 comprising a cellulosic material, a layer 20 comprising a polymer resin or film material, and a second polymer resin or film layer 25 positioned on top of the layer 20. The composite material 10 is attached to fiberglass or other insulation 28. In a preferred embodiment, the composite material 10 has burst strength values of 60 or greater and is particularly effective in improving physical strength (puncture resistance) and decreasing moisture transmission rates versus conventional materials with burst values of approximately 30 using a single layer LDPE of comparable thickness.

The first cellulosic layer 15 can be made of any material comprised primarily of cellulosic fibers. Suitable materials for use as the first layer 15 include, for example, machine-finished or machine-glazed papers, extensible, or other types of paper. An exemplary material for the first layer 15 is paper with a burst strength of 50 to 60 and a basis weight of 30-55 lbs. per 3,000 sq. ft. A preferred embodiment of the present invention comprises a first layer 15 of brown Kraft paper having a basis weight of 30-45 lbs. per 3,000 sq. ft. A paper having a basis weight of 38 lbs is most preferred.

The second layer 20 of the composite coextruded material 10 comprises a polymer resin that, when applied to the first layer 15, increases the overall composite strength (burst) and provides a high moisture barrier (0.50 WVTR or less)/low moisture transmission rate. In a preferred embodiment, the second layer 20 comprises a polymer resin selected from the group consisting of polypropylene homopolymers and copolymers, high density polyethylenes and linear low density polyethylenes. A preferred embodiment of the present invention comprises a second layer 20 of about 2-6 lbs. per 3,000 sq. ft., of low density polyethylene resin that is not pigmented (clear). About 3 lbs per 3,000 sq. ft. is most preferred.

The third layer 25 of the composite coextruded material 10 comprises a high melt index polymer resin (10.0 or higher) and is used as the outside sealant layer. The third layer 25 comprises a polymer resin selected from the group consisting of polypropylene homopolymers and copolymers, high density polyethylenes, and linear low density polyethylenes. A preferred embodiment of the present invention comprises about 3-12 lbs. per 3,000 sq. ft. of low density polyethylene resin that is pigmented with a coloring agent to impart opacity, preferably a black pigment; for example inorganic pigments such as titanium dioxide or barium sulfate (white), a metallic oxide pigment such as an iron oxide, zinc oxide or chromium oxide greens, ultramarine pigments, cadmium pigments and carbon black, among others. A most preferred embodiment comprises about 8 lbs. per 3,000 sq. ft. of low density polyethylene resin.

In a preferred embodiment, the third layer is made of poly comprising about 94% clear and about 6% black. If above 9-10 % black is used it burns holes in the material. Carbon black is the preferred pigment. In a preferred embodiment, infrared lamps are used to heat up the process. If one overheats the black layer, it causes pinholes and not show through.

In use, the paper/coextrusion material is heated and the polymer side is placed next to the fiberglass or other insulation so as to allow the outside, low density polyethylene to adhere to the insulation. The other side of the material may be printed upon using known printing techniques.

The densities of the paper layer 15 and the polymer resin layers 20 and 25 of the composite material 10 can be varied to control the performance of the final structure.

In a preferred embodiment, material 10 can be prepared by coextrusion, extrusion or adhesive lamination or coating as schematically depicted in FIG. 2. The laminating device 30 includes two nip rollers 40, 45, that rotate in opposite directions, as shown by arrows 50, 52. In a typical set-up, the surface temperature of the chill roll 45 is controlled for cooling the layers 20, 25. During this same process the outside of the sealant layer also can be flame or corona (electrically) treated to enhance adhesion or bonding to the fiberglass or other insulation.

The invention has been described by reference to detailed examples. These examples are not meant to limit the scope of the invention. The disclosures of the cited references throughout the application are incorporate by reference herein.

1. A coextruded coated paper material comprising:
a first layer comprising paper;
a second layer comprising a clear polymer resin material; and
a third outside sealant layer comprising a black high melt index polymer resin material.

2. The coextruded material of claim 1 wherein said layers are integrally bonded together.

3. The coextruded material of claim 1 wherein said polymer resin layers provide a moisture/vapor barrier and improved strength.

4. The coextruded material of claim 1 wherein said second layer provides a moisture/vapor barrier layer and a layer that prevents the bleed-through of said outside sealant layer to said first paper layer.

5. The coextruded material of claim 1 wherein said third layer provides adhesion or bonding to insulation.

6. The coextruded material of claim 1 wherein said first, second, and third layers are continuously bonded together such that there are substantially no air pockets in between.

7. The coextruded material of claim 1 wherein said first layer comprises a cellulosic material having a basis weight of about 30-55 lbs. per 3,000 sq. ft.

8. The coextruded material of claim 1 wherein said first layer comprises a cellulosic material having fold retention characteristics.

9. The coextruded material of claim 1 wherein said first layer comprises a cellulosic material selected from the group consisting of machine-finished, machine-glazed, extensible, or Kraft paper.

10. The coextruded material of claim 1 wherein said second layer comprises a polymer resin selected from the group consisting of high or low density polyethylene or polypropylene.

11. The coextruded material of claim 1 wherein said second layer comprises a low density clear polyethylene.

12. The coextruded material of claim 1 wherein said second layer has a thickness of about 2-6 lbs per 3,000 sq, ft.

13. The coextruded material of claim 1 wherein said third layer has a thickness of about 3-12 lbs. per 3,000 sq. ft.

14. The coextruded material of claim 1 wherein said third layer comprises a polymer resin material which is a low density, high melt polyethylene

15. The coextruded material of claim 1 wherein said third layer is flame or corona (electrically) treated to enhance adhesion or bonding to fiberglass or other insulation.

16. The coextruded material of claim 1 wherein said material is faced with a roll or batt of insulation.

17. The coextruded material of claim 1 wherein said material has a burst strength value of approximately 60 or greater.

18. The coextruded material of claim 1 wherein said material has a WVTR value of approximately 0.50 or less.

19. The coextruded material of claim 16 wherein said material provides a barrier to effectively prevent moisture absorption into said insulation.

20. The coextruded material of claim 1 wherein said paper has a release characteristic.

21. A process for making a composite material comprising:
forming two layers of polymer resin materials, a clear polymer resin material and a black low melt polymer resin material;
applying said polymer resin materials to a surface of a first sheet or layer of paper;
conveying said paper and said polymer resin materials into a laminating apparatus and bonding said layers to form an integral composite material.
